(19) United States
(12) Patent Application Publication
(10) Pub. No.: US 2004/0233429 A1
(43) Pub. Date: Nov. 25, 2004

(54) Method and spectrophotometer for exchanging color measurement and diagnostic information over a network

(76) Inventors: Lawrence D. Taylor, Warrington, PA (US); David Slocum, Yardley, PA (US)

Correspondence Address: MOSER, PATTERSON & SHERIDAN L.L.P., 595 SHREWSBURY AVE, STE 100, FIRST FLOOR, SHREWSBURY, NJ, 07702, US

(21) Appl. No.: 10/789,942

(22) Filed: Feb. 27, 2004

Related U.S. Application Data
(60) Provisional application No. 60/451,159, filed on Feb. 28, 2003.
(60) Provisional application No. 60/450,311, filed on Feb. 27, 2003.

(51) Int. Cl. G01J 3/28

(52) U.S. Cl. 356/319

(57) ABSTRACT

A system for calibrating a spectrophotometer includes a spectrophotometer, including a network communication interface, operating in a plurality of modes and producing and implementing diagnostic information. A network communicates with the spectrophotometer via the network communication interface. A remote processor is enabled to communicate with the spectrophotometer directly via the network communication interface. Alternatively, a spectrophotometer having a thin client is disclosed that can operate independently of a local PC.

This application claims the benefit of U.S. Provisional Application No. 60/451,159, filed Feb. 28, 2003, and U.S. Provisional Application No. 60/450,311, filed Feb. 27, 2003.

### BACKGROUND

The present invention relates to color measurement. It finds particular application in conjunction with communicating with color measurement devices via a network (e.g., the Internet) and will be described with particular reference thereto. It will be appreciated, however, that the invention is also amenable to other applications.

Traditionally, a color measurement device (e.g., a spectrophotometer) is connected to a personal computer (PC) via a local communication interface, for example, an RS232 port, or a USB port. The color measurement device is commanded to perform instrument calibration (e.g., black and white calibrations) and reflectance measurements by the PC via the connection. Reflectance data returned by the spectrophotometer to the PC is then applied by a user to appropriate color measurement/analysis software tool(s). The spectrophotometer is also able to be commanded by the PC to present diagnostic information (e.g., standard-tile reflectance values, calibration values, lamp brightness levels) so that the “health” of the instrument may be monitored, to send such diagnostic information to the PC, and to accept corrective commands based on this information as directed by the PC.

One drawback to the traditional system described above is that all the calibration and diagnostic data is maintained locally on, for example, the PC without any central monitoring. Furthermore, it is not possible to download software and/or firmware updates. This requires a service technician to visit the location where the spectrophotometer is used in order to repair the device and/or update associated software or firmware.

The present invention provides a new and improved apparatus and method which addresses the above-referenced problems.

### SUMMARY

In one embodiment, a system for calibrating a spectrophotometer includes a spectrophotometer, including a network communication interface, operating in a plurality of modes and producing diagnostic information. The spectrophotometer using the network communication interface is able to communicate with a remote processor over the network. In one embodiment, the diagnostic information is communicated from the spectrophotometer to the remote processor via the network. The remote processor analyzes the diagnostic information for determining a calibration status of the spectrophotometer. The remote processor controls and corrects the spectrophotometer during the diagnostic mode of operation, as a function of the calibration status, via the network for calibrating the spectrophotometer.

In an alternative embodiment, the spectrophotometer produces diagnostic information and is capable of analyzing the diagnostic information and performing self-correction independently without the aid of the remote processor or a local PC. Namely, the spectrophotometer has built-in capability within the spectrophotometer itself.

In yet another alternative embodiment, the spectrophotometer produces diagnostic information and is capable of analyzing the diagnostic information and performing self-correction independently without the aid of the remote processor or a local PC. However, the spectrophotometer has the capability to communicate with a remote processor to obtain data, and updates, e.g., software updates or maintenance data or instructions.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates an exemplary architecture of a spectrophotometer according to the present invention;

FIG. 2 illustrates a component diagram of a spectrophotometer in a first mode of operation;

FIG. 3 illustrates a component diagram of a spectrophotometer in a second mode of operation in accordance with one embodiment of the present invention; and

FIG. 4 illustrates a component diagram of a spectrophotometer in a third mode of operation in accordance with one embodiment of the present invention.

### DETAILED DESCRIPTION OF ILLUSTRATED EMBODIMENT

In one embodiment, the present system and method provide the capability of operating a spectrophotometer in a plurality of modes (e.g., a traditional mode of operation, a diagnostic mode of operation, and a standalone mode of operation).

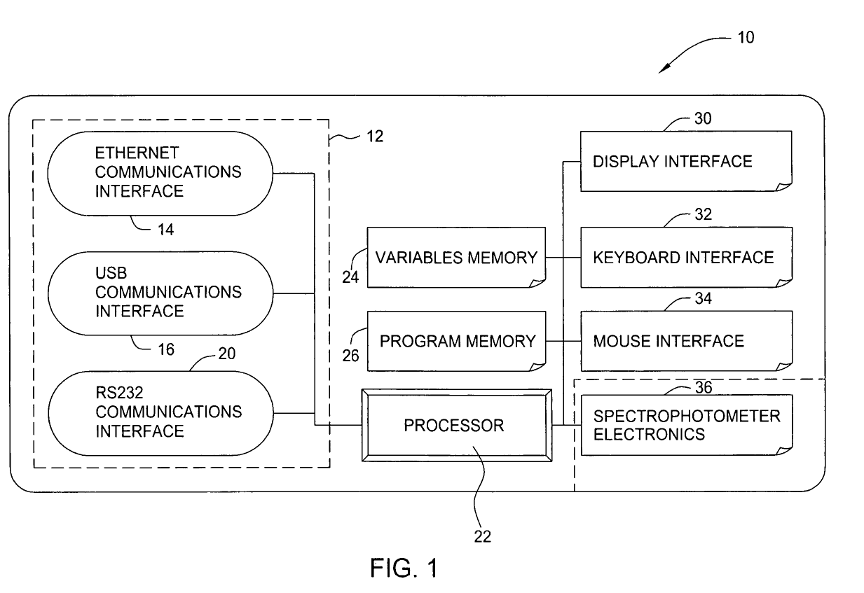

With reference to FIG. 1, an exemplary architecture for a spectrophotometer 10 according to the present invention is illustrated. The spectrophotometer 10 includes at least one of a plurality of communication interfaces 12 e.g., a network communication interface such as Ethernet 14 and the like; and a local communication interface such as a USB interface 16, and an RS232 interface 20. The communication interface 12 communicates with a processor 22, which in turn communicates with various memory devices (e.g., a variables memory device 24 such as a storage drive and a program memory device 26 such as RAM), device interfaces (e.g., a display interface 30, a keyboard interface 32, and a mouse interface 34), and electronics 36 within the spectrophotometer 10. As outlined below, the processor 22 permits the spectrophotometer 10 to operate in any of a plurality (e.g., three (3)) modes of operation. The different operating modes allow spectrophotometers that are either local or remote with respect to color measurement/analysis software tools to have instant access to current color measurement software/calculations and instrument diagnostics. In one embodiment, spectrophotometers may access the color measurement/analysis software tools via the USB and/or RS232 communication interfaces 16, 20, respectively, while other spectrophotometers may access the color measurement/analysis software tools via the Ethernet communication interface 14.

Thus, by having a processor 22 and associated components, the spectrophotometer 10 provides unique functions that are not found in existing spectrophotometers. Namely, the spectrophotometer 10 can independently perform instrument calibration, reflectance measurements or diagnostic functions without the assistance of a local computing device, e.g., a PC connected by a local communication interface.

Furthermore, the spectrophotometer 10 excluding the spectrophotometer electronics 36 can be deemed to be a “thin client” implementation or device. In one embodiment, the thin client device can be implemented as a separate board that is adapted to an existing or a modified spectrophotometer.

It should be noted that a spectrophotometer is broadly a device used to measure, at any of a plurality of wavelengths, what fraction of incident light of that wavelength is absorbed, reflected or transmitted by a material sample. Examples of spectrophotometers are disclosed in US patents D458,167 “Portable spectrophotometer” and U.S. Pat. No. 6,362,886 Portable color measuring device, held by Applied Color Systems, Inc. These patents are herein incorporated by reference into the present disclosure. Thus, existing components or spectrophotometer electronics of a spectrophotometers are illustrated in these references.

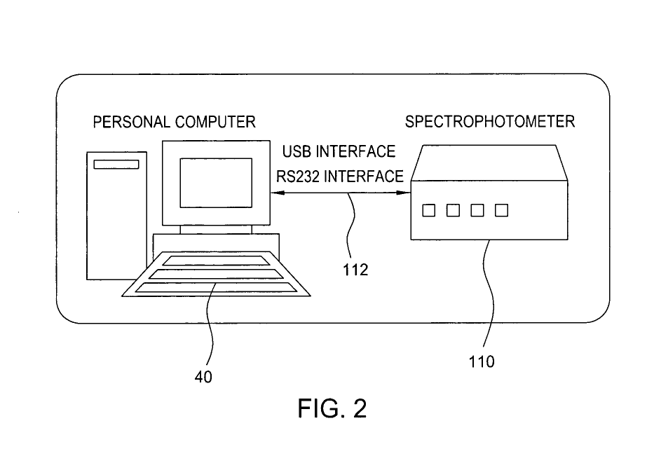

With reference to FIG. 2, a simplified component diagram of a spectrophotometer in the first (traditional) mode of operation is illustrated in accordance with one embodiment of the present invention. For convenience, components illustrated in FIG. 2 that correspond to the respective components illustrated in FIG. 1 are given numerical references greater by 100 than the corresponding components in FIG. 1. New components are designated by new numerals.

In the embodiment illustrated in FIG. 2, the spectrophotometer 110 communicates with a personal computer (PC) 40 via a local communication interface 112. In one embodiment, the local communication interface 112 is a USB interface and/or an RS232 interface. Data is transmitted from the PC 40 to the spectrophotometer 110 for commanding the spectrophotometer 110 to perform instrument calibration (e.g., black and white calibrations) as well as reflectance measurements. The reflectance data returned by the spectrophotometer to the PC 40 is then applied by the user to the appropriate color measurement/analysis software tool(s). In one embodiment, the color measurement/analysis software tool(s) are included in the PC 40. The spectrophotometer 110 is also able to be commanded by the PC 40 to present diagnostic information (e.g., standard-tile reflectance values, calibration values, lamp brightness levels) so that the “health” of the instrument can be monitored, to transmit such information to the PC 40, and to accept corrective commands from the PC 40.

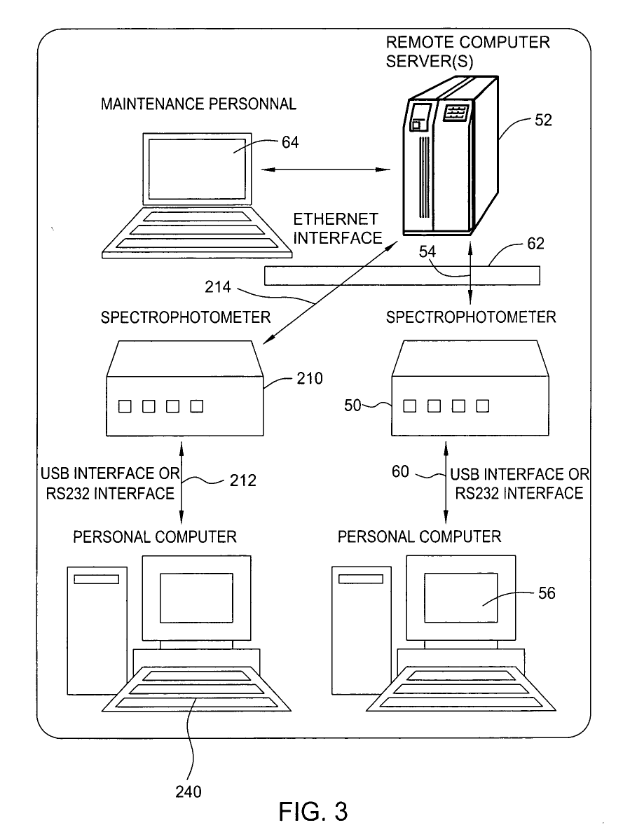

With reference to FIG. 3, a simplified component diagram of spectrophotometers operating in the second (diagnostics) mode of operation is illustrated in accordance with one embodiment of the present invention. For convenience, components illustrated in FIG. 3 that correspond to the respective components illustrated in FIGS. 1 and 2 are given numerical references greater by 200 than the corresponding components in FIGS. 1 and 2. New components are designated by new numerals.

In the embodiment illustrated in FIG. 3, spectrophotometers 210, 50 communicate with a data source 52 (e.g., a remote server) via respective Ethernet communication interfaces 214, 54. Also, the spectrophotometers 210, 50 communicate locally with respective processors (PCs) 240, 56 via local communication interfaces 212, 60 (e.g., either USB communication interfaces or RS232 communication interfaces). In this embodiment, the spectrophotometers 210, 50 communicate with the server 52 via a network 62 (e.g., the internet or an intranet) and therefore, are “remote” from the server 52. Therefore, the server 52 is referred to as a remote server. On the other hand, the spectrophotometers 210, 50 communicate with the PCs 240, 56 merely via local communication lines (e.g., cables) connected to the local communication interfaces 212, 60 on the spectrophotometers 210, 50, respectively. Therefore, the PCs 240, 56 are referred to as local processors or local PCs. The remote server 52 also communicates with a maintenance input/output device 64 (e.g., a PC) for permitting a maintenance operator to control the server 52. It is contemplated in this embodiment that the data source 52 includes the color measurement/analysis software tool(s).

Although it is to be understood that the remote server 52 is capable of communicating with a plurality of spectrophotometers 210, 50 during a diagnostic operation, the diagnostic operation of only one of the spectrophotometers 210 will only be described below in detail.

During operation, a local operator commands one of the spectrophotometers (e.g., 210), via the PC 240, to enter the second (diagnostics) operating mode. After entering the diagnostics mode, the spectrophotometer 210 connects with the remote server 52 via the Ethernet communications interface 214. As discussed above, although only one of the spectrophotometers is described as communicating with the remote server 52, it is to be understood that the remote server 52 is capable of communicating with a plurality of spectrophotometers at any one time.

The spectrophotometer 210 transmits diagnostic information to the remote server 52. In one embodiment the diagnostic information includes standard-tile reflectance values, calibration values, lamp brightness levels, etc. The diagnostic information is displayed on the maintenance input/output device 64. Then maintenance personnel evaluate the diagnostic information displayed on the maintenance input/output device 64. A determination is made whether any corrective action (e.g., calibration) is warranted. If corrective action is warranted, the maintenance personnel and/or the software may indicate a calibration status of the spectrophotometer is “calibrate;” otherwise, the maintenance personnel and/or the software may indicate a calibration status of the spectrophotometer is “not calibrate.”

If it is determined that corrective action is warranted, maintenance personnel instruct the server 52, via the maintenance input/output device 64, to take remote control of the spectrophotometer 210. Then, the maintenance personnel remotely command the spectrophotometer 210, via the maintenance input/output device 64, to perform any of the normal operating functions, diagnostic functions, corrective functions, or download software updates.

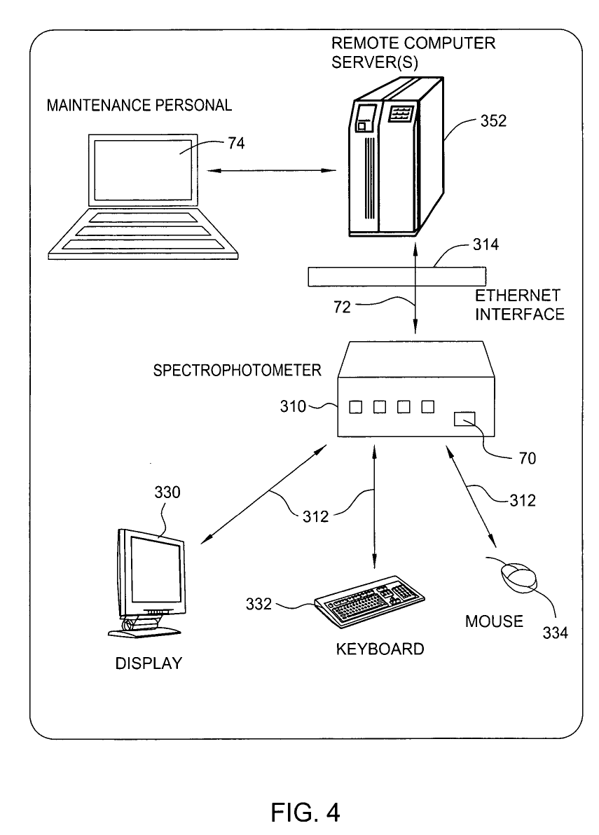

With reference to FIG. 4, a simplified component diagram of a spectrophotometer operating in the third (standalone) mode of operation is illustrated in accordance with one embodiment of the present invention. For convenience, components illustrated in FIG. 4 that correspond to the respective components illustrated in FIG. 1-3 are given numerical references greater by 300 than the corresponding components in FIGS. 1-3. New components are designated by new numerals.

In this embodiment, the spectrophotometer 310 communicates with the data source 352 (e.g., a remote server) including color measurement/analysis software tool(s) via an Ethernet communication interface 314. The spectrophotometer 310 includes a processor 70 and communicates with a plurality of peripheral devices including a display device 330, an input device 332, and a pointing device 334 via communication interfaces 312 on the spectrophotometer 310. In one embodiment, the communication interfaces 312 are PS2 and/or VGA RGB ports; however, other types of communication interfaces are also contemplated.

In this embodiment, the spectrophotometer 310 communicates with the server 352 via a network 72 (e.g., the internet or an intranet) and therefore, is “remote” from the server 352. Therefore, the server 352 is referred to as a remote server. On the other hand, the spectrophotometer 310 communicates with the peripheral devices 330, 332, 334 merely via local communication lines (e.g., cables) connected to the communication interfaces 312 on the spectrophotometers. Therefore, the peripheral devices 330, 332, 334 are referred to as “local” input/output (I/O) devices with respect to the spectrophotometer 310. The remote server 352 also communicates with a maintenance input device 74 (e.g., a PC) for permitting a maintenance operator to control the server 352. In the standalone mode of operation, the functions of the traditional and diagnostics modes of operation are combined without requiring a PC. It should be noted a local PC is no longer necessary to be connected to the spectrophotometer 310.

During operation in the standalone mode, the spectrophotometer 310 may be commanded to perform instrument calibration (e.g., black and white calibrations), reflectance measurements, or diagnostic functions; such commands may be effected by maintenance personnel via the maintenance PC 74, or locally via the peripheral devices 330, 332, 334. Reflectance data gathered by the spectrophotometer 310 is presented locally on the display device 330. The local user also has the capability of activating color measurement/analysis software tools that are located on the remote server 352 or locally within the spectrophotometer. The data is then presented locally on the display device 330. Optionally, the data is stored on the remote server 352 for future retrieval.

It is to be appreciated that in the various modes of operation described above, the spectrophotometer may be corrected by transmitting a new calibration file from the remote computer to the spectrophotometer. The calibration file may be calculated or generated by software in the remote computer based on how much drifting is occurring between calibrations. Therefore, in this embodiment, the calibration file is tracked and generated at the remote computer.

Furthermore, data from a spectrophotometer is transmitted via the network to the remote computer server. The remote computer server includes a means for processing the data to determine whether the spectrophotometer is operating within tolerance. The remote computer server also includes software for generating the calibration file, which is transmitted back to the spectrophotometer, for bringing the spectrophotometer back within specified tolerances, via the network. Similarly, the necessity of any software and/or firmware upgrade is determined in the remote computer as a function of the maintenance data transmitted directly from the spectrophotometer. Then, any necessary updates are transmitted from the remote computer directly to the spectrophotometer via the network.

In another embodiment, the software for generating the calibration file is stored locally on the spectrophotometer or a local PC. In this embodiment, the calibration file is generated locally (e.g., in the spectrophotometer or within the local PC and then transmitted to the spectrophotometer). Then, only summary results (e.g., indicating that a new calibration file was generated and how much the device was operating in or out of tolerance before and after the new calibration file was generated) are transmitted to the remote computer server via the network. One advantage of maintaining the software for generating the calibration file locally is that less data is transmitted over the network between the spectrophotometer (or local PC) and the remote computer. Maintenance data may still be transmitted to the remote computer. Also, software and firmware upgrades may still be transmitted from the remote computer directly to the spectrophotometer or PC.

In one embodiment, the focus of diagnostic information of the spectrophotometer is communicated over networks (e.g., internet) for achieving direct communication of the Spectrophotometer without the aid of a separate PC.

Another embodiment expands the idea of a Spectrophotometer communicating over the network (without the aid of a separate PC), however it goes much further in two key areas: a) the Spectrophotometer communicates directly to a remote server/database where the object is to store certain information and download certain information that may further characterize the performance or even the operation of the Spectrophotometer (e.g., information could be extracted from the central database that would set the standard operating parameters of the spectrophotometer (e.g., world wide standardization of operation)); and b) the block labeled “Spectrophotometer” extends the key functions of the Spectrophotometer (without a PC) much further.

As discussed above, configuration files received from a central database actually configure the way the spectrophotometer (or a group of spectrophotometers) operate. In this way standard operation of a group of spectrophotometers is controlled (e.g., worldwide) from a central location. In one embodiment, data for controlling the operation of the spectrophotometers is transmitted between the central location and the spectrophotometer(s) via the internet. However, it is also contemplated, in other embodiments, that the data for controlling the operation of the spectrophotometers be transmitted between the central location and the spectrophotometer(s) via an intranet (e.g., a corporate intranet).

Also, the configuration from a remote server could also set various parameters including: 1) Calibration interval, 2) Illuminant setting(s), 3) Performance reporting interval, 4) Reporting of instrument history, 5) Upon login, which database is data stored in 6) How the data will be organized, 7) User information, time, date, etc. Upon beginning a session (e.g., login), it is contemplated, in one embodiment, that a preconfigured file be transmitted from the central server to the spectrophotometer to be calibrated. It is contemplated that this preconfiguration file is created by a global manager. Also, the preconfiguration file would automatically “set-up” the spectrophotometer based on the identity of the user.

It is also contemplated that instead of merely indicating whether the spectrophotometer needs to be calibrated, a formulation is determined indicating what type of calibration is necessary. For example, data including instructions may be sent to/from the spectrophotometer indicating the respective amounts of certain colors need to be corrected (e.g., red, blue, yellow). It is contemplated that such a formulation may take place over the network.

It is also contemplated that the spectrophotometer includes a switch that may be set to either “save” (hold) or “transmit” the data. If the switch is set to “transmit,” the data is transmitted to the remote server. If the switch is set to save (hold), the data is saved locally until a later time when the data switch is set to “transmit.”

In another embodiment, an operator local to the spectrophotometer (if allowed in the configuration) can chose to “submit” the sample or simply evaluate the sample locally before final submission.

In another embodiment, it is also contemplated that the data from a group of spectrophotometers worldwide can be used to make logistical decisions (e.g., which products, fabrics, plastics, etc. are the nearest in color (regardless of location) and should be grouped together for further processing or manufacturing). Also, management information derived from the data may be sent from the remote server to the remote spectrophotometer location regarding action to be taken for a given batch of product(s), (e.g., acceptance, shipping, grouping, sorting, disposal, use).

Also, it is contemplated that the daily, weekly, etc, activity of a group of spectrophotometers can be reported from a central database (remote or otherwise) to determine the world wide performance of a group of spectrophotometers without the aid a separate PC.

It should be noted that one or more components of the present invention can be represented by one or more software applications (or even a combination of software and hardware, e.g., using application specific integrated circuits (ASIC)), where the software is loaded from a storage medium (e.g., a magnetic or optical drive or diskette) and operated by the processor in the memory. As such, one or more components (including associated data structures) of the present invention can be stored on a computer readable medium, e.g., RAM memory, magnetic or optical drive or diskette and the like.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/we claim:

1. A communication system, comprising:
a spectrophotometer having a network communication interface for communicating with a network, wherein said spectrophotometer operates in at least one mode; and
a remote processor for communicating information directly with said spectrophotometer via said network.

2. The system of claim 1, wherein said information comprises diagnostic information received by said remote processor directly from said spectrophotometer via said network for determining a calibration status of said spectrophotometer.

3. The system of claim 2, wherein if said calibration status of said spectrophotometer is “not calibrated,” the remote processor transmits data to the spectrophotometer for calibrating or correcting the spectrophotometer.

4. The system of claim 2, wherein said remote processor allows a remote user to operate a color measurement/analysis software for analyzing the diagnostic information.

5. The system of claim 4, wherein said color measurement/analysis software resides with said remote processor.

6. The system of claim 4, wherein said color measurement/analysis software resides with said spectrophotometer.

7. The system of claim 2, wherein the spectrophotometer includes a processor for communicating directly with said remote processor via said network communication interface.

8. The system of claim 4, further including:
a local computing device for communicating with the spectrophotometer via a local communication interface to allow local access of said spectrophotometer.

9. The system of claim 8, wherein said color measurement/analysis software resides with said local computing device.

10. The system of claim 1, wherein if said at least one mode is a traditional mode of operation, then said spectrophotometer allows local access of a color measurement/analysis software at the spectrophotometer for analyzing the diagnostic information.

11. The system of claim 1, wherein said network communication interface is an Ethernet interface.

12. The system of claim 1, wherein said information communicated directly to said spectrophotometer by said remote processor allows said remote processor to control said spectrophotometer or to configure one or more parameters.

13. The system of claim 12, wherein said one or more parameters comprise at least one of calibration interval, corrective parameters for subsequent measurements, illuminant setting, performance reporting interval, reporting of instrument history, database where data is stored, the manner in which data will be organized, and user information.

14. The system of claim 2, wherein said diagnostic information comprises at least one of standard-tile reflectance values, calibration values, and lamp brightness levels.

15. A method for exchanging information between a spectrophotometer and a remote processor, comprising:
providing a spectrophotometer with a network communication interface for communicating with a network, wherein said spectrophotometer operates in at least one mode; and
providing a remote processor for communicating information directly with said spectrophotometer via said network.

16. The method of claim 15, further comprising:
receiving diagnostic information by said remote processor directly from said spectrophotometer via said network; and
determining a calibration status of said spectrophotometer and directing adjustment of the spectrophotometer.

17. The method of claim 16, further comprising:
transmitting data to the spectrophotometer directly by said remote processor for calibrating the spectrophotometer if said calibration status of said spectrophotometer is “not calibrated,”.

18. The method of claim 16, further comprising:
allowing a remote user to operate a color measurement/analysis software for analyzing the diagnostic information.

19. The method of claim 18, wherein said color measurement/analysis software resides with said remote processor.

20. The method of claim 18, wherein said color measurement/analysis software resides with said spectrophotometer.

21. The method of claim 18, further comprising:
providing a local computing device for communicating with the spectrophotometer via a local communication interface to allow local access of said spectrophotometer.

22. The method of claim 15, further comprising:
forwarding information directly to said spectrophotometer by said remote processor to control said spectrophotometer or to configure one or more parameters.

23. A color measuring apparatus operating in at least one mode, comprising:
a spectrophotometer;
a processor; and
a network communication interface for allowing said color-measuring apparatus to communicate directly with a remote processor.

24. A spectrophotometer operating in at least one mode, comprising spectrophotometer electronics;
a processor; and
a network communication interface for allowing said spectrophotometer to communicate information directly with a remote processor.

25. The spectrophotometer of claim 24, wherein said information comprises diagnostic information sent directly by said spectrophotometer to said remote processor via said network for determining a calibration status of said spectrophotometer.

26. The spectrophotometer of claim 25, wherein if said calibration status of said spectrophotometer is “not calibrated,” then the spectrophotometer receives data from said remote processor for calibrating the spectrophotometer.

27. The spectrophotometer of claim 25, wherein said remote processor allows a remote user to operate a color measurement/analysis software for analyzing the diagnostic information.

28. The spectrophotometer of claim 27, wherein said color measurement/analysis software resides with said remote processor.

29. The spectrophotometer of claim 28, wherein said color measurement/analysis software resides with said spectrophotometer.

30. The spectrophotometer of claim 24, further including:
a local communication interface for communicating with a local computing device to allow local access of said spectrophotometer.

31. The spectrophotometer of claim of claim 30, wherein said color measurement/analysis software resides with said local computing device.

32. The spectrophotometer of claim 24, wherein if said at least one mode is a traditional mode of operation, then said spectrophotometer allows local access of a color measurement/analysis software at the spectrophotometer for analyzing the diagnostic information.

33. The spectrophotometer of claim 24, wherein said network communication interface is an Ethernet interface.

34. The spectrophotometer of claim 24, wherein said information communicated directly to said spectrophotometer by said remote processor allows said remote processor to control said spectrophotometer or to configure one or more parameters.

35. The spectrophotometer of claim of claim 34, wherein said one or more parameters comprise at least one of calibration interval, illuminant setting, performance reporting interval, reporting of instrument history, database where data is stored, manner data will be organized, and user information.

36. The spectrophotometer of claim of claim 25, wherein said diagnostic information comprises at least one of standard-tile reflectance values, calibration values, and lamp brightness levels.

37. A method of operating a spectrophotometer, comprising
providing a network communication interface for allowing said spectrophotometer to communicate information directly with a remote processor; and
forwarding and receiving information directly with said remote processor.

38. The method of claim 37, wherein said information comprises diagnostic information sent directly by said spectrophotometer to said remote processor via said network for determining a calibration status of said spectrophotometer.

39. The method of claim 38, wherein if said calibration status of said spectrophotometer is “not calibrated,” then the spectrophotometer receives data from said remote processor for calibrating the spectrophotometer.

40. The method of claim 38, wherein said remote processor allows a remote user to operate a color measurement/analysis software for analyzing the diagnostic information.

41. The method of claim 37, further including:
communicating with a local computing device via a local communication interface to allow local access of said spectrophotometer.

42. The method of claim 37, wherein if said at least one mode is a traditional mode of operation, then said spectrophotometer allows local access of a color measurement/analysis software at the spectrophotometer for analyzing the diagnostic information.

43. The method of claim 37, wherein said network communication interface is an Ethernet interface.

44. A remote server, comprising
a processor; and
a network communication interface for allowing said remote server to communicate information directly with a remote spectrophotometer via a network.

45. The remote server of claim 44, wherein said information comprises diagnostic information received directly by said remote processor via said network from said spectrophotometer for determining a calibration status of said spectrophotometer.

46. The remote server of claim 45, wherein if said calibration status of said spectrophotometer is “not calibrated,” then said remote processor sends data directly to the spectrophotometer for calibrating the spectrophotometer.

47. The remote server of claim 45, wherein said remote processor allows a remote user to operate a color measurement/analysis software for analyzing the diagnostic information.

48. The remote server of claim 47, wherein said color measurement/analysis software resides with said remote processor.
